(19) United States
(12) Patent Application Publication
(10) Pub. No.: US 2010/0116596 A1
(43) Pub. Date: May 13, 2010

(54) SERVICE CONTROLLER FOR DETERMINING CROWDING IN AN ELEVATOR CAR

(75) Inventors: Kato Mitsuru, Yachimata-shi (JP); Toshiyuki Fujii, Setagaya-ku (JP); Masafumi Okawa, Tomisato-shi (JP); Kenzo Ishige, Sakura-shi (JP); Motohiro Higashide, Tomisato-shi (JP)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Otis Elevator Company, Farmington, CT (US)

(21) Appl. No.: 12/450,977

(22) PCT Filed: Nov. 29, 2007
(86) PCT No.: PCT/US2007/024593

§ 371 Date: Oct. 20, 2009

(30) Foreign Application Priority Data
Apr. 17, 2007 (JP) 2007-107996

(51) Int. Cl. B66B 1/34

(52) U.S. Cl. 187/392

(57) ABSTRACT

A service controller for crowded elevator cars includes an illuminating apparatus (4) furnished in a top part of a car (1) that is configured to illuminate the car (1) interior, at least one elongated light sensor unit (8) constituted by multiple light sensors (10) on a base member (9) and installed along corner regions (7a, 7b) formed between a vertical wall surface (5) of the car and the car's floor surface (6), and a judgment device (11) that is configured to determine whether there is passenger boarding space in the car (1) based on the output of the light sensors (10).

### BACKGROUND

The present invention relates to a service controller that determines whether there is passenger boarding space in an elevator car.

Japanese Kokai Patent Application No. 2006-16127, for example, proposed one such type of service controller for crowded elevator cars. With the technology described in Japanese Kokai Patent Application No. 2006-16127, light sensors are provided in multiple sections of the car floor surface, which is divided into squares. The sensors sense changes in lighting on the floor surface caused by blocking (e.g., by passengers or cargo) of light from the illuminating apparatus illuminating the car interior. Whether there is passenger boarding space in the car is determined based on the sensed lighting. When there is no passenger boarding space in the car, landing calls are not serviced.

With the technology described in Japanese Kokai Patent Application No. 2006-16127, light sensing devices are arranged individually for each section of the car floor. As a result, it is necessary to embed the respective light sensors throughout the car floor surface. Further, the work to retrofit existing elevators with such sensors is particularly complicated.

In light of the foregoing, the present invention aims to resolve one or more of the aforementioned issues that afflict elevator systems.

### SUMMARY

Embodiments of the present invention include a service controller for crowded elevator cars including, among other possible things, an illuminating apparatus furnished in a top part of a car that is configured to illuminate the car interior, at least one elongated light sensor unit installed along a corner region formed between a vertical sidewall and a floor of the car, and a judgment device that is configured to: (a) determine whether there is passenger boarding space in the car based on an output of the light sensor unit, and (b) produce a crowded car signal when the judgment device has determined that there is no passenger boarding space in the car.

Embodiments of the present invention also include a method of determining whether there is passenger boarding space in an elevator car. This method includes, among other possible steps: transmitting light from a top part of the elevator car to a corner region of the floor of the car; sensing an amount of light transmitted from the top part of the elevator car to the corner of region of the floor of the car when the car is unloaded; establishing a reference value of light based on the amount of light from the top part of the elevator car to the corner region of the floor sensed when the car is unloaded; sensing an amount of light transmitted from the top part of the elevator car to the corner region of the floor of the car when the car is at least partially loaded; comparing the amount of light sensed when the car is at least partially loaded to the reference value; and producing a crowded car signal when the amount of light sensed when the car is at least partially loaded is at or below the reference value.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are hereafter briefly described.

FIG. 1 is a plan view of an embodiment of an elevator car and an embodiment of a service controller according to the present invention.

FIG. 2 is a cross sectional view, taken at line at A-A in FIG. 1, of the elevator car.

FIG. 3 is a flow chart showing an embodiment of a processing procedure whereby an embodiment of a judgment device determines whether there is passenger boarding space in the elevator car shown in FIG. 1.

FIG. 4 is a flow chart showing an embodiment of a control sequence in an embodiment of a main controller that may be used in conjunction with the elevator car and the service controller shown in FIG. 1.

### DETAILED DESCRIPTION

Efforts have been made throughout the drawings to use the same or similar reference numerals for the same or like components.

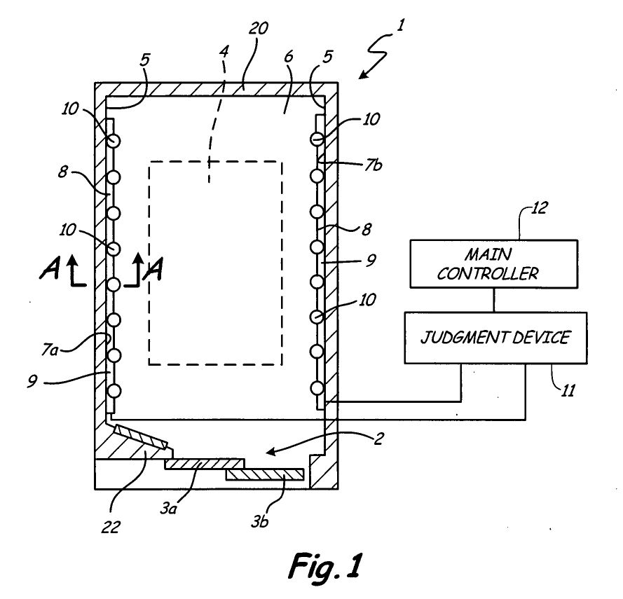

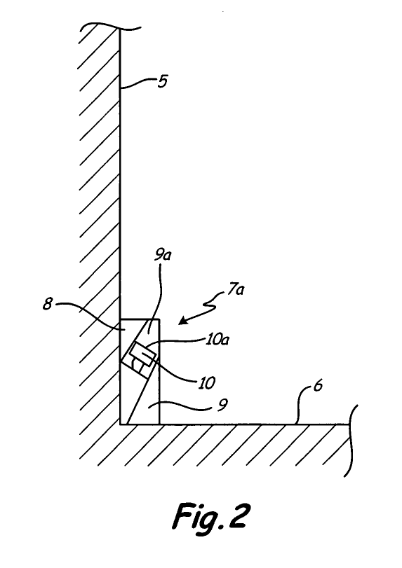

FIG. 1 shows a service controller for crowded elevator cars as an embodiment of the present invention, and shows an overview of an elevator car in plan view. The service controller, as later described in detail, is formed of an illuminating apparatus 4, one or more elongated light sensor units 8, and a judgment device 11. FIG. 2 is a cross section at A-A in FIG. 1. Elevator car 1, as shown in FIGS. 1 and 2, is basically rectangular, and car entrance/exit 2 is opened and closed by two sliding doors 3a and 3b. An illuminating apparatus 4 is furnished in a top part of the car such as, for example, in approximately the center of the ceiling of car 1. The interior of car 1 is illuminated by illuminating apparatus 4.

Elongated light sensor units 8 are provided along two corner regions 7a and 7b of car 1 formed between a generally rectangular floor 6 of the car 1 and two sidewalls 5 (i.e., the walls of the car 1 toward and away from which the doors 3a, 3b move). Multiple receiving recesses 9a that open toward illuminating apparatus 4 are formed at generally equal spacing along the length direction in base members 9 of each light sensor unit 8. A light sensor 10 that receives light from illuminating apparatus 4 is arranged in each receiving recess 9a such that its light-receiving face 10a faces illuminating apparatus 4. Using relatively inexpensive items, such as CdS cells, photodiodes, phototransistors, or the like, as light sensors 10 is preferred for achieving lower costs. And while not shown, it is desirable that the open part of receiving recess 9a be closed with a transparent sensor cover. The judgment device 11, which determines whether there is passenger boarding space in the car based on the amount of light sensed by each light sensor 10, is connected to the two light sensor units 8. The judgment device 11 is also connected to elevator main controller 12.

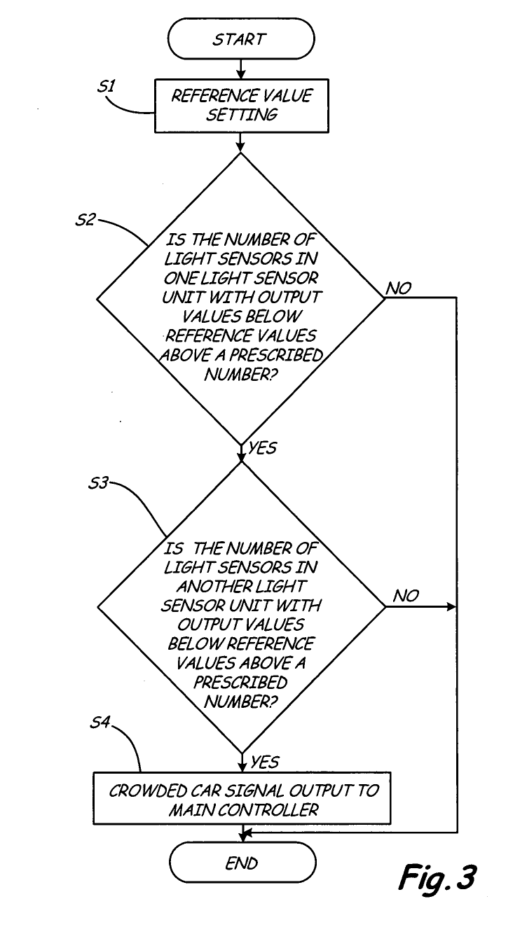

FIG. 3 is a flow chart showing the processing procedure whereby judgment device 11 determines whether there is passenger boarding space in the car. With a controller for crowded elevator operation constituted as described above, as shown in FIG. 3, judgment device 11 first sets a reference value corresponding to each light sensor 10 based on the full output value of each light sensor 10 when: (a) the car entrance/exit 2 is fully closed; (b) the interior of car 1 is illuminated by illuminating apparatus 4; and (c) the car is unloaded (step S1). For example, a value of 50% of the full output value for each light sensor 10 in the aforementioned reference state can be set as the reference value. Here, if there is a light sensor 10 for which the full output value at this time is outside of a preset range, then such a light sensor 10 can be excluded based on a determination that the sensor is broken and/or non-responsive.

The aforementioned reference values for each light sensor are compared to the output values of each light sensor 10 when a passenger boards car 1 and either just before or just after the entrance/exit 2 is fully closed. It is then determined (step S2) whether the number of light sensors 10 in a light sensor unit 8 having output values below the aforementioned reference values is above a predetermined number (for example, 80% of the number of light sensors 10 in a light sensor unit 8).

If the number of light sensors 10 in a light sensor unit 8 having output values below the aforementioned reference values is above the aforementioned prescribed number, then it is determined (step S3) whether the number of light sensors 10 in the other light sensor unit 8 having output values below the aforementioned reference values is above the prescribed number. If the number of light sensors 10 in the other light sensor unit 8 having output values below the aforementioned reference values is above the prescribed number, then it is determined (step S4) that there is no remaining passenger boarding space in the car, and a crowded car signal is output to main controller 12. That is, judgment device 11 determines whether there is passenger boarding space in car 1 based on changes (relative to the aforementioned reference state) in the output values from light sensors 10 produced when passengers, cargo, or the like in car 1 prevent the light from illuminating apparatus 4 from reaching the sensors 10.

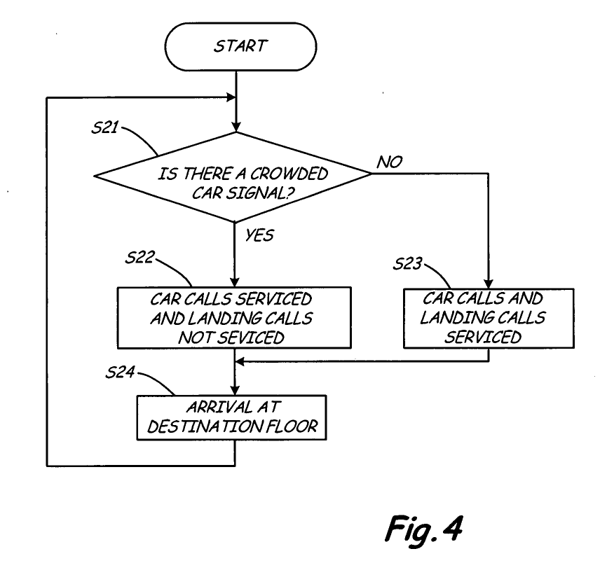

FIG. 4 is a flow chart showing the control sequence in main controller 12. As shown in FIG. 4, main controller 12 confirms whether a crowded car signal has been input when car 1 is traveling (step S21). When a crowded car signal has been input, car calls are serviced while landing calls are not serviced (step S22). When no crowded car signal has been input, both landing calls and car calls are serviced (step S23). Further, when car 1 reaches a destination floor designated by a landing call or car call (and passengers board and/or exit car 1), it is again determined (step S24) whether a crowded car signal has been input.

Therefore, with this embodiment, because light sensor units 8 are installed in corners 7a and 7b, there is the advantage that the service controller for crowded elevator cars can easily be installed in existing elevators, in particular when retrofitting or the like. Although in the embodiment shown, light sensor units 8 are installed in corners 7a and 7b of car 1 formed between the two sidewalls 5 and the floor 6, it is also possible to install a light sensor unit 8 in car 1 in a corner between the floor 6 and a rear wall 20 and/or between the floor 6 and a front wall 22. Moreover, although the embodiment shown depicted sensors 8 installed between two sidewalls 5 and the floor 6, sensors 8 could be installed in the corner between the floor 6 and only one wall, or in corners between the floor 6 and three, four, or more walls.

This application claims priority to, and hereby incorporates by reference in its entirety, Japanese Priority Application No. JP2007-107996, which was filed on Apr. 17, 2007.

The aforementioned discussion is intended to be merely illustrative of the present invention and should not be construed as limiting the appended claims to any particular embodiment or group of embodiments. Thus, while the present invention has been described in particular detail with reference to specific exemplary embodiments thereof, it should also be appreciated that numerous modifications and changes may be made thereto without departing from the broader and intended scope of the invention as set forth in the claims that follow.

The specification and drawings are accordingly to be regarded in an illustrative manner and are not intended to limit the scope of the appended claims. In light of the foregoing disclosure of the present invention, one versed in the art would appreciate that there may be other embodiments and modifications within the scope of the present invention. Accordingly, all modifications attainable by one versed in the art from the present disclosure within the scope of the present invention are to be included as further embodiments of the present invention. The scope of the present invention is to be defined as set forth in the following claims.

What is claimed is:

1. A service controller for crowded elevator cars comprising:
an illuminating apparatus furnished in a top part of a car that is configured to illuminate the car interior;
at least one elongated light sensor unit installed along a corner region formed between a vertical sidewall of the car and a floor of the car; and
a judgment device that is configured to: (a) determine whether there is passenger boarding space in the car based on an output of the light sensor unit; and
(b) produce a crowded car signal when the judgment device has determined that there is no passenger boarding space in the car.

2. The service controller of claim 1, wherein the elongated light sensor unit comprises multiple light sensors arranged in a row, and wherein each light sensor is configured to receive light from the illuminating apparatus.

3. The service controller of claim 1, wherein the service controller comprises two elongated light sensor units that are respectively installed at two corner regions formed between the floor and first and second sidewalls.

4. The service controller of claim 3, wherein the two sidewalls are on opposite sides of the car.

5. The service controller of claim 1, wherein the judgment device is configured to instruct an elevator controller not to service landing calls for the elevator car when the crowded car signal is produced by the judgment device.

6. The service controller of claim 1, wherein the illuminating apparatus is provided in a ceiling of the elevator car.

7. The service controller of claim 1, wherein the judgment device is configured to determine whether there is passenger boarding space in the car based on changes in the output of the light sensor unit relative to when the car is unloaded.

8. A method of determining whether there is passenger boarding space in an elevator car, the method comprising the steps of:
transmitting light from a top part of the elevator car to a corner region of the floor of the car;
sensing an amount of light transmitted from the top part of the elevator car to the corner region of the floor of the car when the car is unloaded;
establishing a reference value of light based on the amount of light from the top part of the elevator car to the corner region of the floor sensed when the car is unloaded;
sensing an amount of light transmitted from the top part of the elevator car to the corner region of the floor of the car when the car is at least partially loaded;
comparing the amount of light sensed when the car is at least partially loaded to the reference value; and
producing a crowded car signal when the amount of light sensed when the car is at least partially loaded is at or below the reference value.

9. A method of controlling elevator car service based on the amount of passenger boarding space in an elevator car, the method comprising the steps of:
transmitting light from a top part of the elevator car to a corner region of the floor of the car;
sensing an amount of light transmitted from the top part of the elevator car to the corner region of the floor of the car when the car is unloaded;
establishing a reference value of light based on the amount of light from the top part of the elevator car to the corner region of the floor sensed when the car is unloaded;
sensing an amount of light transmitted from the top part of the elevator car to the corner region of the floor of the car when the car is at least partially loaded;
comparing the amount of light sensed when the car is at least partially loaded to the reference value; and
controlling the elevator car service based on the comparison between the amount of light sensed and the reference value.
